(19) United States
(12) Patent Application Publication
(10) Pub. No.: US 2026/0107231 A1
(43) Pub. Date: Apr. 16, 2026

(54) METHOD AND ELECTRONIC DEVICE TO ENHANCE POWER SAVING

(71) Applicant: MEDIATEK INC., Hsinchu City (TW)

(72) Inventors: Lung-Wen CHEN, Hsinchu City (TW); Wan-Ting HUANG, Hsinchu City (TW); Chia-Chun HUANG, Hsinchu City (TW); Kuan-Lin CHEN, Hsinchu City (TW)

(21) Appl. No.: 19/357,240

(22) Filed: Oct. 14, 2025

Related U.S. Application Data
(60) Provisional application No. 63/707,816, filed on Oct. 16, 2024.

(51) Int. Cl. H04W 52/02; H04W 24/08; H04W 64/00

(52) U.S. Cl. CPC H04W 52/0254; H04W 24/08; H04W 64/00

(57) ABSTRACT

A method to enhance power saving, applied a UE operating in a connected mode with a network, is provided. The mobility of the UE is detected to obtain a first result. Whether the UE is located at a cell edge is detected to obtain a second result. Interactive operations between the user and the UE are detected to obtain a third result. A measurement strategy is determined based on at least one of the first result, the second result, and the third result. Certain measurements are stopped or slowed down based on the measurement strategy.

### CROSS REFERENCE TO RELATED APPLICATIONS

This application claims the benefit of U.S. provisional application No. 63/707,816, filed on Oct. 16, 2024, the entirety of which is incorporated by reference herein.

### BACKGROUND OF THE INVENTION

### Field of the Invention

The present invention relates to an electronic device, and, in particular, it relates to a method and an electronic device to enhance power saving when the electronic device operates in a connected mode with a network.

### Description of the Related Art

A user's daily life may primarily revolve around two main locations, such as the workplace and the home. The activity range in these two places is very fixed, and the frequency of using a mobile phone in these places is not always high. For a UE in idle mode, the 3GPP specification defines an optional system information block (SIB) and an optional SIB (R16) UE relaxed Measurement.

The optional SIB lets the UE stop partial measurement under certain reference signal received power (RSRP) or reference signal received quality (RSRQ) conditions. However, the limitation is as follows: Even if the UE does not fulfill the certain RSRP or RSRQ conditions, and if the UE is under low mobility and not in the cell edge, the UE can still reduce radio resource management (RRM) since the variance of the signal environment is low.

The optional SIB (R16) UE relaxed Measurement reduce RRM when the UE is under low mobility and not in the cell edge. However, the limitations are as follows: First, not all networks support the above-mentioned feature, which is dependent on network deployment. Second, user interactive operations are not considered. The mobility tolerance will be different according to the different user interactive operations. For a UE in connected mode, there is no 3GPP defined solution.

### BRIEF SUMMARY OF THE INVENTION

An embodiment of the present invention provides a method to enhance power savings. The method is applied to user equipment (UE) operating in a connected mode, connected with a network. The mobility of the UE is detected to obtain a first result. It is detected whether the UE is located at a cell edge to obtain a second result. Interactive operations between the user and the UE are detected to obtain a third result. A measurement strategy is determined based on at least one of the following: the first result, the second result, and the third result. Certain measurements are stopped or slowed down based on the measurement strategy.

According to the method described above, the step of detecting the mobility of the UE to obtain the first result includes the following step: The mobility of the UE is detected to obtain the first result based on raw data from GPS, gyroscope, motion sensor, and measurement data. The first result includes a static-low mobility, a walking-low mobility, and a not low mobility. The static-low mobility indicates that the motion of the UE is stationary at a fixed place. The walking-low mobility indicates that the motion of the UE is walking or is similar to walking. The not low mobility includes other motions of the UE except for the static-low mobility and the walking-low mobility.

According to the method described above, the step of detecting the mobility of the UE to obtain the first result based on the raw data from the GPS, the gyroscope, the motion sensor, and the measurement data includes the following steps. The first result is assigned as a maximum mobility obtained based on the raw data from the GPS, the gyroscope, the motion sensor, and the measurement data. Alternatively, the first result is calculated based on the raw data from the GPS, the gyroscope, the motion sensor, and the measurement data, and weightings respectively corresponding to the GPS, the gyroscope, the motion sensor, and the measurement data. Alternatively, an AI model is used to infer the first result. The AI model is trained based on the raw data from the GPS, the gyroscope, the motion sensor, and the measurement data.

According to the method described above, the step of detecting whether the UE is located at the cell edge to obtain the second result includes the following step. Whether the UE is located at the cell edge between a serving cell and neighbor cells is detected to obtain the second result based on signal strength and quality from the serving cell, and signal strength and quality relative to the neighbor cells.

According to the method described above, the second result includes a not cell edge result and a cell edge result.

According to the method described above, the step of detecting the interactive operations between the user and the UE to obtain the third result includes the following step. The interactive operations between the user and the UE are detected to obtain the third result based on the on or off state of the screen, the frequency of user screen touches, and the frequency of data transmission between the UE and the network.

According to the method described above, the third result includes a no interactive result, a low interactive result, a medium interactive result, and a high interactive result.

According to the method described above, the measurement strategy includes the following steps. A first action is performed to stop inter-frequency or inter radio access technology (inter-RAT) measurements, and stop intra-frequency measurements except for a serving cell. Alternatively, a second action is performed to stop the inter-frequency or inter-RAT measurements, and extend the cycle of the intra-frequency measurements by K times. Alternatively, a third action is performed to extend the cycle of the inter-frequency or inter-RAT measurements by M times, and extend the cycle of the intra-frequency measurements by K times. M and K are larger than one. Alternatively, a fourth action for normal measurements is performed.

According to the method described above, the network does not configure relaxed Measurement-r16 to the UE.

The method further includes the following steps. The first action is performed in response to meeting a first condition that the first result is the static-low mobility and the third result is the no interactive result or the low interactive result. The second action is performed in response to meeting a second condition that the first result is the walking-low mobility, the second result is the not cell edge result, and the third result is the no interactive result or the low interactive result. The third action is performed in response to meeting a third condition that the second result is the cell edge result and the third result being the no interactive result or the low interactive result. The fourth action is performed in response to not meeting the first condition, the second condition, or the third condition.

According to the method described above, the UE enters an idle mode, and the network configures relaxed Measurement-r16 to the UE.

According to the method described above, the network configures relaxed Measurement-r16 with only low Mobility Evaluation-r16 IEs to the UE. The method further includes the following steps. Third Generation Partnership Project (3GPP) specification is followed to perform relaxed measurements for intra cells, inter cells, and inter-RAT (IRAT) cells in response to the UE fulfilling relaxed measurement criteria. The first action is performed in response to the UE fulfilling relaxed measurement criteria, and meeting a first condition that the first result is the static-low mobility and the third result is the no interactive result or the low interactive result. The second action is performed in response to the UE fulfilling relaxed measurement criteria, and meeting a second condition that the first result is the walking-low mobility, the second result is the not cell edge result, and the third result being the no interactive result or the low interactive result. The fourth action is performed in response to the UE fulfilling relaxed measurement criteria, and not meeting the first condition or the second condition.

The method further includes the following steps. The first action is performed in response to the UE not fulfilling relaxed measurement criteria and meeting the first condition. The second action is performed in response to the UE not fulfilling relaxed measurement criteria and meeting the second condition. The fourth action is performed in response to the UE not fulfilling relaxed measurement criteria and not meeting the first condition or the second condition.

An embodiment of the present invention also provides an electronic device. The electronic device operates in a connected mode with a network. The electronic device includes a storage and a processor. The storage store codes for enhancing power saving. The processor is electrically connected to the storage. The processor executes the codes to do the following actions. The processor detects the mobility of the UE to obtain a first result. The processor detects whether the UE is located at a cell edge to obtain a second result. The processor detects interactive operations between the user and the UE to obtain a third result. The processor determines a measurement strategy based on at least one of the first result, the second result, and the third result. The processor stops or slows down certain measurements based on the measurement strategy.

According to the electronic device described above, the processor detects the mobility of the UE to obtain the first result based on raw data from GPS, gyroscope, motion sensor, and measurement data. The first result includes a static-low mobility, a walking-low mobility, and a not low mobility. The static-low mobility indicates that the motion of the UE is stationary at a fixed place. The walking-low mobility indicates that the motion of the UE is walking or is similar to walking. The not low mobility includes other motions of the UE except for the static-low mobility and the walking-low mobility.

According to the electronic device described above, the processor assigns the first result as a maximum mobility obtained based on the raw data from the GPS, the gyroscope, the motion sensor, and the measurement data. Alternatively, the processor calculates the first result based on the raw data from the GPS, the gyroscope, the motion sensor, and the measurement data, and weightings respectively corresponding to the GPS, the gyroscope, the motion sensor, and the measurement data. Alternatively, the processor uses an AI model to infer the first result. The AI model is trained based on the raw data from the GPS, the gyroscope, the motion sensor, and the measurement data.

According to the electronic device described above, the processor detects whether the UE is located at the cell edge between a serving cell and neighbor cells to obtain the second result based on signal strength and quality from the serving cell, and signal strength and quality relative to the neighbor cells.

According to the electronic device described above, the second result includes a not cell edge result and a cell edge result.

According to the electronic device described above, the processor detects the interactive operations between the user and the UE to obtain the third result based on the on or off state of the screen, the frequency of user screen touches, and the frequency of data transmission between the UE and the network.

According to the electronic device described above, the third result includes a no interactive result, a low interactive result, a medium interactive result, and a high interactive result.

According to the electronic device described above, the measurement strategy includes the following actions. The processor performs a first action to stop inter-frequency or inter radio access technology (inter-RAT) measurements, and stop intra-frequency measurements except for a serving cell. Alternatively, the processor performs a second action to stop the inter-frequency or inter-RAT measurements, and extend the cycle of the intra-frequency measurements by K times. Alternatively, the processor performs a third action to extend the cycle of the inter-frequency or inter-RAT measurements by M times, and extend the cycle of the intra-frequency measurements by K times. M and K are larger than one. Alternatively, the processor performs a fourth action for normal measurements.

According to the electronic device described above, the network does not configure relaxed Measurement-r16 to the UE.

According to the electronic device described above, the processor performs the first action in response to meeting a first condition that the first result is the static-low mobility and the third result is the no interactive result or the low interactive result. The processor performs the second action in response to meeting a second condition that the first result is the walking-low mobility, the second result is the not cell edge result, and the third result is the no interactive result or the low interactive result. The processor performs the third action in response to meeting a third condition that the second result is the cell edge result and the third result being the no interactive result or the low interactive result. The processor performs the fourth action in response to not meeting the first condition, the second condition, or the third condition.

According to the electronic device described above, the UE enters an idle mode, and the network configures relaxed Measurement-r16 to the UE.

According to the electronic device described above, the network configures relaxed Measurement-r16 with only low Mobility Evaluation-r16 IEs to the UE. The processor follows Third Generation Partnership Project (3GPP) specification to perform relaxed measurements for intra cells, inter cells, and inter-RAT (IRAT) cells in response to the UE fulfilling relaxed measurement criteria. The processor performs the first action in response to the UE fulfilling relaxed measurement criteria, and meeting a first condition that the first result is the static-low mobility and the third result is the no interactive result or the low interactive result. The processor performs the second action in response to the UE fulfilling relaxed measurement criteria, and meeting a second condition that the first result is the walking-low mobility, the second result is the not cell edge result, and the third result being the no interactive result or the low interactive result. The processor performs the fourth action in response to the UE fulfilling relaxed measurement criteria, and not meeting the first condition or the second condition.

According to the electronic device described above, the processor performs the first action in response to the UE not fulfilling relaxed measurement criteria and meeting the first condition. The processor performs the second action in response to the UE not fulfilling relaxed measurement criteria and meeting the second condition. The processor performs the fourth action in response to the UE not fulfilling relaxed measurement criteria and not meeting the first condition or the second condition.

### BRIEF DESCRIPTION OF THE DRAWINGS

The present invention can be more fully understood by reading the subsequent detailed description and examples with references made to the accompanying drawings.

FIG. 1 is a flow chart of a method to enhance power saving applied to user equipment (UE) operating in a connected mode with a network in accordance with some embodiments of the present invention.

FIG. 2 is a detail flow chart of step S102 in FIG. 1 in accordance with some embodiments of the present invention.

FIG. 3 is a detail flow chart of step S104 in FIG. 1 in accordance with some embodiments of the present invention.

FIG. 4 is a schematic diagram of a network system 400 in accordance with some embodiments of the present invention.

FIG. 5 is a schematic diagram of an electronic device 420 in FIG. 4 in accordance with some embodiments of the present invention.

### DETAILED DESCRIPTION OF THE INVENTION

In order to make the above purposes, features, and advantages of some embodiments of the present invention more comprehensible, the following is a detailed description in conjunction with the accompanying drawing.

Certain terms are used throughout the description and following claims to refer to particular components. As one skilled in the art will understand, electronic equipment manufacturers may refer to a component by different names. This document does not intend to distinguish between components that differ in name but not function. It is understood that the words “comprise”, “have” and “include” are used in an open-ended fashion, and thus should be interpreted to mean “include, but not limited to . . . ”. Thus, when the terms “comprise”, “have” or “include” used in the present invention are used to indicate the existence of specific technical features, values, method steps, operations, units or components. However, it does not exclude the possibility that more technical features, numerical values, method steps, work processes, units, components, or any combination of the above can be added.

The directional terms used throughout the description and following claims, such as: “on”, “up”, “above”, “down”, “below”, “front”, “rear”, “back”, “left”, “right”, etc., are only directions referring to the drawings. Therefore, the directional terms are used for explaining and not used for limiting the present invention. Regarding the drawings, the drawings show the general characteristics of methods, structures, or materials used in specific embodiments. However, the drawings should not be construed as defining or limiting the scope or properties encompassed by these embodiments. For example, for clarity, the relative size, thickness, and position of each layer, each area, or each structure may be reduced or enlarged.

When the corresponding component such as layer or area is referred to as being “on another component”, it may be directly on this other component, or other components may exist between them. On the other hand, when the component is referred to as being “directly on another component (or the variant thereof)”, there is no component between them. Furthermore, when the corresponding component is referred to as being “on another component”, the corresponding component and the other component have a disposition relationship along a top-view/vertical direction, the corresponding component may be below or above the other component, and the disposition relationship along the top-view/vertical direction is determined by the orientation of the device.

It should be understood that when a component or layer is referred to as being “connected to” another component or layer, it can be directly connected to this other component or layer, or intervening components or layers may be present. In contrast, when a component is referred to as being “directly connected to” another component or layer, there are no intervening components or layers present.

The electrical connection or coupling described in this disclosure may refer to direct connection or indirect connection. In the case of direct connection, the endpoints of the components on the two circuits are directly connected or connected to each other by a conductor line segment, while in the case of indirect connection, there are switches, diodes, capacitors, inductors, resistors, other suitable components, or a combination of the above components between the endpoints of the components on the two circuits, but the intermediate component is not limited thereto.

The words “first”, “second”, and “third” are used to describe components. They are not used to indicate the priority order of or advance relationship, but only to distinguish components with the same name.

It should be noted that the technical features in different embodiments described in the following can be replaced, recombined, or mixed with one another to constitute another embodiment without depart in from the spirit of the present invention.

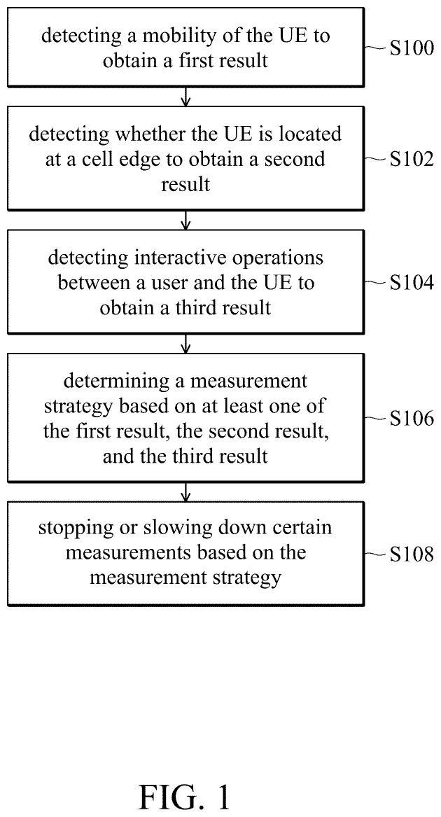

FIG. 1 is a flow chart of a method to enhance power saving applied to user equipment (UE) operating in a connected mode with a network in accordance with some embodiments of the present invention. As shown in FIG. 1, the method of the present invention includes the following steps. The mobility of the UE is detected to obtain a first result (step S100). Whether the UE is located at a cell edge is detected to obtain a second result (step S102). Interactive operations between the user and the UE are detected to obtain a third result (step S104). A measurement strategy is determined based on at least one of the first result, the second result, and the third result (step S106). Certain measurements are stopped or slowed down based on the measurement strategy (step S108).

In some embodiment, step S100 includes the following step. The mobility of the UE is detected to obtain the first result based on raw data from GPS, gyroscope, motion sensor, and measurement data. The first result includes a static-low mobility, a walking-low mobility, and a not low mobility. The static-low mobility indicates that the motion of the UE is stationary at a fixed place. The walking-low mobility indicates that the motion of the UE is walking or is similar to walking. The not low mobility includes other motions of the UE except for the static-low mobility and the walking-low mobility. In some embodiments, the static-low mobility indicates that a speed of the UE is lower than 1 kilometer per hour. The walking-low mobility indicates that the speed of the UE is between 1 kilometer per hour and 5 kilometers per hour. The not low mobility indicates that the speed of the UE is higher than 5 kilometers per hour.

In some embodiment, the step of detecting the mobility of the UE to obtain the first result based on the raw data from the GPS, the gyroscope, the motion sensor, and the measurement data in step S100 includes the following steps. The first result is assigned as a maximum mobility obtained based on the raw data from the GPS, the gyroscope, the motion sensor, and the measurement data. Alternatively, the first result is calculated based on the raw data from the GPS, the gyroscope, the motion sensor, and the measurement data, and weightings respectively corresponding to the GPS, the gyroscope, the motion sensor, and the measurement data. Alternatively, an AI model is used to infer the first result. The AI model is trained based on the raw data from the GPS, the gyroscope, the motion sensor, and the measurement data.

For example, the first result may be obtained by the following equation 1 or 2.

$$UE mobility ( KM / hr ) = Max\_Mobility ( GPS , Gyroscope , Motion Sensor , Measurement data ) . \qquad equation 1$$

$$UE mobility ( KM / hr ) = {F}_{GPS} \times {Mobility}_{GPS} + {F}_{Gyro} \times {Mobility}_{GYro} + {F}_{Motion} \times Mobility + {F}_{MeasData} \times {Mobility}_{MeasData} , wherein {F}_{GPS} + {F}_{Gyro} + {F}_{Motion} + {F}_{MeasData} = 1. \qquad equation 2$$

In equation 1, Max_Mobility (GPS, Gyroscope, Motion Sensor, Measurement data) means that the first result is assigned as a maximum mobility obtained based on the raw data from the GPS, the gyroscope, the motion sensor, and the measurement data. In equation 2, F_{GPS} is the weighs of the GPS and Mobility_{GPS} is the mobility obtained from the GPS. F_{Gyro} is the weighs of the Gyroscope and Mobility_{Gyro} is the mobility obtained from the gyroscope. F_{Motion} is the weighs of the motion sensor and Mobility is the mobility obtained from the motion sensor. F_{MeasData} is the weighs of the measurement data and Mobility_{MeasData} is the mobility obtained from the measurement data.

In some embodiment, step S102 includes the following step. The present invention detects whether the UE is located at the cell edge between a serving cell and neighbor cells to obtain the second result based on signal strength and quality from the serving cell, and signal strength and quality relative to the neighbor cells. The second result includes a not cell edge result and a cell edge result.

In some embodiment, step S104 includes the following step. The present invention detects the interactive operations between the user and the UE to obtain the third result based on the on or off state of the screen, the frequency of user screen touches, and the frequency of data transmission between the UE and the network. The third result includes a no interactive result, a low interactive result, a medium interactive result, and a high interactive result.

In some embodiment, the measurement strategy in step S106 includes the following actions. The present invention performs a first action to stop inter-frequency or inter radio access technology (inter-RAT) measurements, and stop intra-frequency measurements except for a serving cell. Alternatively, the present invention performs a second action to stop the inter-frequency or inter-RAT measurements, and extend the cycle of the intra-frequency measurements by K times. Alternatively, the present invention performs a third action to extend the cycle of the inter-frequency or inter-RAT measurements by M times, and extend the cycle of the intra-frequency measurements by K times. M and K are larger than one. Alternatively, the present invention performs a fourth action for normal measurements.

In some embodiments, the network does not configure relaxed Measurement-r16 to the UE. The present invention performs the first action in response to meeting a first condition that the first result is the static-low mobility and the third result is the no interactive result or the low interactive result. The present invention performs the second action in response to meeting a second condition that the first result is the walking-low mobility, the second result is the not cell edge result, and the third result is the no interactive result or the low interactive result. The present invention performs the third action in response to meeting a third condition that the second result is the cell edge result and the third result being the no interactive result or the low interactive result. The present invention performs the fourth action in response to not meeting the first condition, the second condition, or the third condition.

In some embodiments, the UE enters an idle mode, and the network configures relaxed Measurement-r16 to the UE. The network configures relaxed Measurement-r16 with only low Mobility Evaluation-r16 IEs to the UE. The present invention follows Third Generation Partnership Project (3GPP) specification to perform relaxed measurements for intra cells, inter cells, and inter-RAT (IRAT) cells in response to the UE fulfilling relaxed measurement criteria. The present invention performs the first action in response to the UE fulfilling relaxed measurement criteria, and meeting a first condition that the first result is the static-low mobility and the third result is the no interactive result or the low interactive result. The present invention performs the second action in response to the UE fulfilling relaxed measurement criteria, and meeting a second condition that the first result is the walking-low mobility, the second result is the not cell edge result, and the third result being the no interactive result or the low interactive result. The present invention performs the fourth action in response to the UE fulfilling relaxed measurement criteria, and not meeting the first condition or the second condition.

In some embodiments, the UE enters the idle mode, and the network configures relaxed Measurement-r16 to the UE. The network configures relaxed Measurement-r16 with only low Mobility Evaluation-r16 IEs to the UE. The present invention performs the second action in response to the UE not fulfilling relaxed measurement criteria and meeting the first condition. The present invention performs the second action in response to the UE not fulfilling relaxed measurement criteria and meeting the second condition. The present invention performs the fourth action in response to the UE not fulfilling relaxed measurement criteria and not meeting the first condition or the second condition.

In some embodiments, the UE enters the idle mode, and the network configures relaxed Measurement-r16 to the UE. The network configures relaxed Measurement-r16 with only cell Edge Evaluation-r16 IEs to the UE. The present invention follows 3GPP specification to perform relaxed measurements for intra cells, inter cells, and inter-RAT (IRAT) cells in response to the UE fulfilling relaxed measurement criteria. The present invention performs the first action in response to the UE fulfilling relaxed measurement criteria, and meeting the first condition that the first result is the static-low mobility and the third result is the no interactive result or the low interactive result. The present invention performs the second action in response to the UE fulfilling relaxed measurement criteria, and meeting the second condition that the first result is the walking-low mobility, the second result is the not cell edge result, and the third result being the no interactive result or the low interactive result. The present invention performs the fourth action in response to the UE fulfilling relaxed measurement criteria, and not meeting the first condition or the second condition.

In some embodiments, the UE enters the idle mode, and the network configures relaxed Measurement-r16 to the UE. The network configures relaxed Measurement-r16 with only cell Edge Evaluation-r16 IEs to the UE. The present invention performs the first action in response to the UE not fulfilling relaxed measurement criteria and meeting the first condition. The present invention performs the second action in response to the UE not fulfilling relaxed measurement criteria and meeting the second condition. The present invention performs the third action in response to the UE not fulfilling relaxed measurement criteria and meeting the third condition. The present invention performs the fourth action in response to the UE not fulfilling relaxed measurement criteria and not meeting the first condition, the second condition, or the third condition.

In some embodiments, the UE enters the idle mode, and the network configures relaxed Measurement-r16 to the UE. The network configures relaxed Measurement-r16 with both low Mobility Evaluation-r16 and cell Edge Evaluation-r16 IEs to the UE. The present invention follows 3GPP specification to perform relaxed measurements for intra cells, inter cells, and inter-RAT (IRAT) cells in response to the UE fulfilling relaxed measurement criteria. The present invention performs the first action in response to the UE fulfilling relaxed measurement criteria, and meeting the first condition that the first result is the static-low mobility and the third result is the no interactive result or the low interactive result. The present invention performs the second action in response to the UE fulfilling relaxed measurement criteria, and meeting the second condition that the first result is the walking-low mobility, the second result is the not cell edge result, and the third result being the no interactive result or the low interactive result. The present invention performs the fourth action in response to the UE fulfilling relaxed measurement criteria, and not meeting the first condition or the second condition.

In some embodiments, the UE enters the idle mode, and the network configures relaxed Measurement-r16 to the UE. The network configures relaxed Measurement-r16 with both low Mobility Evaluation-r16 and cell Edge Evaluation-r16 IEs to the UE. The present invention performs the first action in response to the UE not fulfilling relaxed measurement criteria and meeting the first condition. The present invention performs the second action in response to the UE not fulfilling relaxed measurement criteria and meeting the second condition. The present invention performs the third action in response to the UE not fulfilling relaxed measurement criteria and meeting the third condition. The present invention performs the fourth action in response to the UE not fulfilling relaxed measurement criteria and not meeting the first condition, the second condition, or the third condition.

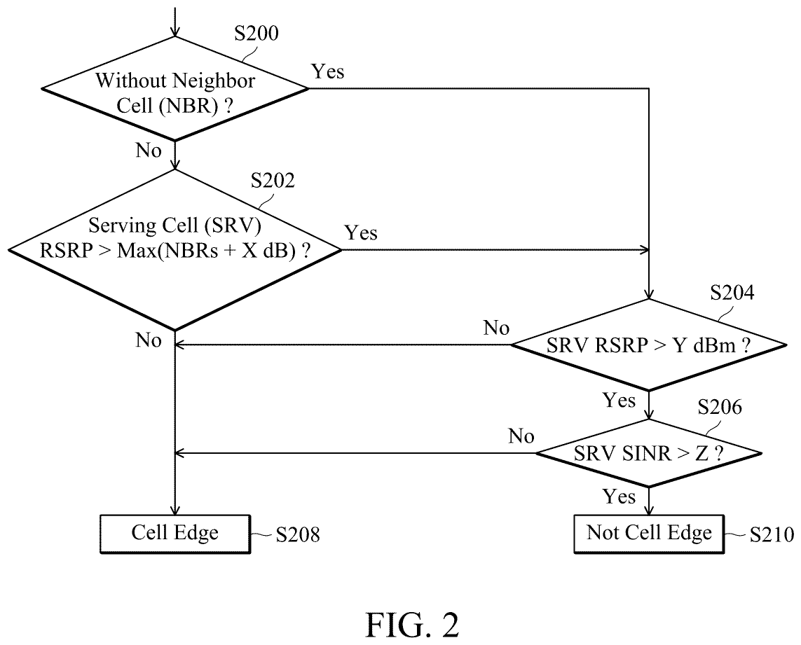

FIG. 2 is a detail flow chart of step S102 in FIG. 1 in accordance with some embodiments of the present invention. As shown in FIG. 2, the present invention determines whether there are neighbor cells or not in step S200. If there are the neighbor cells (that is, the answer is “no” in step S200), the present invention further determines whether the RSRP of the serving cell is larger than the maximum value of the neighbor cells' RSRP adding an X dB in step S202. If the answer is “no” in step S202, the present invention determines that the UE is located at the cell edge in step S208. If there are no neighbor cells (that is, the answer is “yes” in step S200), the present invention further determines whether the serving cell's RSRP is larger than Y dbm in step S204. Similarly, if the answer is “yes” in step S202, the determines whether the serving cell's RSRP is larger than Y dbm in step S204.

If the serving cell's RSRP is larger than Y dbm in step S204, the present invention further determines whether the serving cell's signal to interference plus noise ratio (SINR) is larger than Z in step S206. If serving cell's RSRP is not larger than Y dbm in step S204, the present invention determines that the UE is located at the cell edge in step S208. If the serving cell's SINR is larger than Z in step S206, the present invention determines that the UE is not located at the cell edge in step S210. If the serving cell's SINR is not larger than Z in step S206, the present invention determines that the UE is located at the cell edge in step S208. In some embodiments, X, Y, and Z are fine-tuned by the UE.

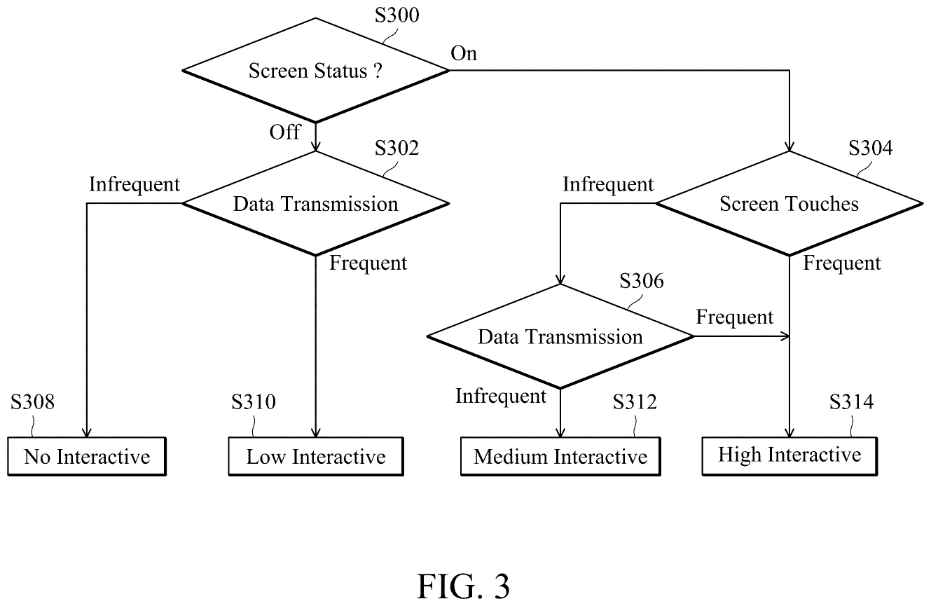

FIG. 3 is a detail flow chart of step S104 in FIG. 1 in accordance with some embodiments of the present invention. As shown in FIG. 3, the present invention determines whether the screen status of the UE is on or off in step S300. If the screen status of the UE is off in step S300, the present invention further determines the data transmission between the UE and the network is infrequent or frequent in step S302. If the data transmission between the UE and the network is infrequent, the present invention determines that the third result is an no interactive result in step S308. If the data transmission between the UE and the network is frequent, the present invention determines that the third result is a low interactive result in step S310.

If the screen status of the UE is on in step S300, the present invention determines the screen touches of the UE is infrequent or frequent in step S304. If the screen touches of the UE are infrequent, the present invention further determines the data transmission between the UE and the network is infrequent or frequent in step S306. If the data transmission between the UE and the network is infrequent, the present invention determines that the third result is a medium interactive result in step S312. If the data transmission between the UE and the network is frequent, the present invention determines that the third result is a high interactive result in step S314. Furthermore, if the screen touches of the UE are frequent, the present invention also determines that the third result is the high interactive result in step S314.

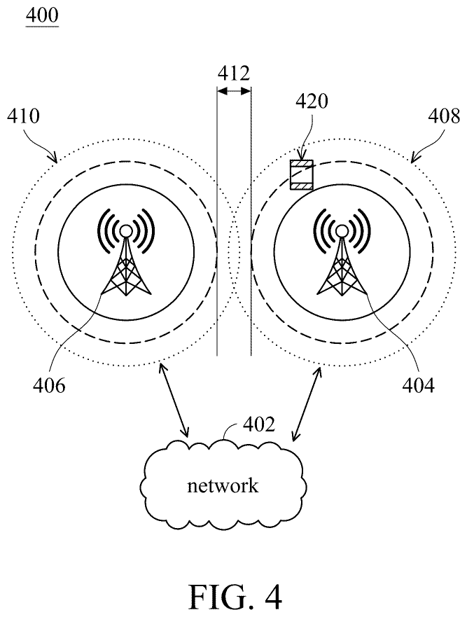

FIG. 4 is a schematic diagram of a network system 400 in accordance with some embodiments of the present invention. As shown in FIG. 4, the network system 400 includes a network 402, a base station 404, a base station 406, and a UE 420. The UE is connected to the network 402 through a serving cell 408 generated by the base station 404. The UE is connected to the network 402 through a neighbor cell 410 generated by the base station 406. A cell edge 412 is marked between the serving cell 408 and the neighbor cell 410.

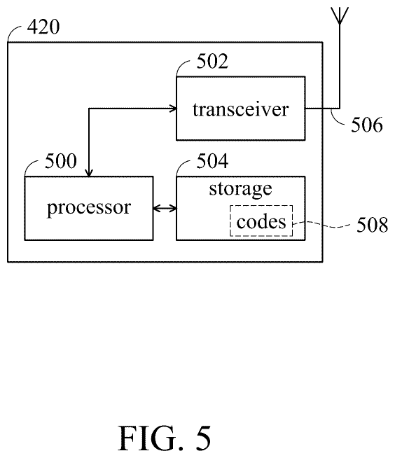

FIG. 5 is a schematic diagram of an electronic device 420 in FIG. 4 in accordance with some embodiments of the present invention. As shown in FIG. 5, the electronic device 420 includes a processor 500, a transceiver 502, an antenna 506, and a storage 504. The storage 504 store codes 508 for enhancing power saving. The processor 500 is electrically connected to the storage 504 and the transceiver 502. The transceiver 502 is electrically connected to the antenna 506. The electronic device 420 operates in a connected mode with the network 402. That is, the processor 500 operates in the connected mode with the network 402 through the transceiver 502 and the antenna 506. In some embodiments, the electronic device 420 may be a UE.

The processor 500 executes the codes 508 to perform the following actions. The processor 500 detects a mobility of the electronic device 420 to obtain a first result. The processor 500 detects whether the electronic device 420 is located at the cell edge 412 to obtain a second result. The processor 500 detects interactive operations between the user and the electronic device 420 to obtain a third result. The processor 500 determines a measurement strategy based on at least one of the first result, the second result, and the third result. The processor 500 stops or slows down certain measurements based on the measurement strategy.

In some embodiments, the processor 500 detects the mobility of the electronic device 420 to obtain the first result based on raw data from GPS, gyroscope, motion sensor, and measurement data. The first result includes the static-low mobility, the walking-low mobility, and the not low mobility. The static-low mobility indicates that a motion of the electronic device 420 is stationary at a fixed place. The walking-low mobility indicates that the motion of the electronic device 420 is walking or is similar to walking. The not low mobility includes other motions of the electronic device 420 except for the static-low mobility and the walking-low mobility.

In some embodiments, the processor 500 assigns the first result as a maximum mobility obtained based on the raw data from the GPS, the gyroscope, the motion sensor, and the measurement data measured by the electronic device 420. Alternatively, the processor 500 calculates the first result based on the raw data from the GPS, the gyroscope, the motion sensor, and the measurement data, and weightings respectively corresponding to the GPS, the gyroscope, the motion sensor, and the measurement data. Alternatively, the processor 500 uses an AI model to infer the first result. The AI model is trained based on the raw data from the GPS, the gyroscope, the motion sensor, and the measurement data.

In some embodiments, the processor 500 detects whether the electronic device 420 is located at the cell edge 412 between the serving cell 408 and the neighbor cell 410 to obtain the second result based on signal strength and quality from the serving cell 408, and signal strength and quality relative to the neighbor cell 410. In some embodiments, the second result includes a not cell edge result and a cell edge result.

In some embodiments, the processor 500 detects the interactive operations between the user and the electronic device 420 to obtain the third result based on the on or off state of the screen, the frequency of user screen touches, and the frequency of data transmission between the electronic device 420 and the network 402. In some embodiments, the third result includes a no interactive result, a low interactive result, a medium interactive result, and a high interactive result.

In some embodiments, the measurement strategy includes the following actions. The processor 500 performs a first action to stop inter-frequency or inter radio access technology (inter-RAT) measurements, and stop intra-frequency measurements except for the serving cell 408. Alternatively, the processor 500 performs a second action to stop the inter-frequency or inter-RAT measurements, and extend the cycle of the intra-frequency measurements by K times. Alternatively, the processor 500 performs a third action to extend the cycle of the inter-frequency or inter-RAT measurements by M times, and extend the cycle of the intra-frequency measurements by K times. M and K are larger than one. Alternatively, the processor 500 performs a fourth action for normal measurements.

In some embodiments, the network 402 does not configure relaxed Measurement-r16 to the electronic device 420. The processor 500 performs the first action in response to meeting a first condition that the first result is the static-low mobility and the third result is the no interactive result or the low interactive result. The processor 500 performs the second action in response to meeting a second condition that the first result is the walking-low mobility, the second result is the not cell edge result, and the third result is the no interactive result or the low interactive result. The processor 500 performs the third action in response to meeting a third condition that the second result is the cell edge result and the third result being the no interactive result or the low interactive result. The processor 500 performs the fourth action in response to not meeting the first condition, the second condition, or the third condition.

In some embodiments, the electronic device 420 enters an idle mode, and the network 402 configures relaxed Measurement-r16 to the electronic device 420. The network 402 configures relaxed Measurement-r16 with only low Mobility Evaluation-r16 IEs to the electronic device 420. The processor 500 follows 3GPP specification to perform relaxed measurements for intra cells, inter cells, and inter-RAT (IRAT) cells in response to the electronic device 420 fulfilling relaxed measurement criteria. The processor 500 performs the first action in response to the electronic device 420 fulfilling relaxed measurement criteria, and meeting a first condition that the first result is the static-low mobility and the third result is the no interactive result or the low interactive result. The processor 500 performs the second action in response to the electronic device 420 fulfilling relaxed measurement criteria, and meeting a second condition that the first result is the walking-low mobility, the second result is the not cell edge result, and the third result being the no interactive result or the low interactive result. The processor 500 performs the fourth action in response to the electronic device 420 fulfilling relaxed measurement criteria, and not meeting the first condition or the second condition.

In some embodiments, the processor 500 performs the first action in response to the electronic device 420 not fulfilling relaxed measurement criteria and meeting the first condition. The processor 500 performs the second action in response to the electronic device 420 not fulfilling relaxed measurement criteria and meeting the second condition. The processor 500 performs the fourth action in response to the electronic device 420 not fulfilling relaxed measurement criteria and not meeting the first condition or the second condition.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

1. A method to enhance power saving, applied to a user equipment (UE) operating in a connected mode with a network, comprising:
detecting a mobility of the UE to obtain a first result;
detecting whether the UE is located at a cell edge to obtain a second result;
detecting interactive operations between a user and the UE to obtain a third result;
determining a measurement strategy based on at least one of the first result, the second result, and the third result, and
stopping or slowing down certain measurements based on the measurement strategy.

2. The method as claimed in claim 1, wherein the step of detecting the mobility of the UE to obtain the first result comprises:
detecting the mobility of the UE to obtain the first result based on raw data from GPS, gyroscope, motion sensor, and measurement data;
wherein the first result comprises a static-low mobility, a walking-low mobility, and a not low mobility;
wherein the static-low mobility indicates that motion of the UE is stationary at a fixed place; the walking-low mobility indicates that the motion of the UE is walking or is similar to walking; the not low mobility includes other motions of the UE except for the static-low mobility and the walking-low mobility.

3. The method as claimed in claim 2, wherein the step of detecting the mobility of the UE to obtain the first result based on the raw data from the GPS, the gyroscope, the motion sensor, and the measurement data comprises:
assigning the first result as a maximum mobility obtained based on the raw data from the GPS, the gyroscope, the motion sensor, and the measurement data; or
calculating the first result based on the raw data from the GPS, the gyroscope, the motion sensor, and the measurement data, and weightings respectively corresponding to the GPS, the gyroscope, the motion sensor, and the measurement data; or
using an AI model to infer the first result; wherein the AI model is trained based on the raw data from the GPS, the gyroscope, the motion sensor, and the measurement data.

4. The method as claimed in claim 1, wherein the step of detecting whether the UE is located at the cell edge to obtain the second result comprises:
detecting whether the UE is located at the cell edge between a serving cell and neighbor cells to obtain the second result based on signal strength and quality from the serving cell, and signal strength and quality relative to the neighbor cells.

5. The method as claimed in claim 2, wherein the second result comprises a not cell edge result and a cell edge result.

6. The method as claimed in claim 1, wherein the step of detecting the interactive operations between the user and the UE to obtain the third result comprises:
detecting the interactive operations between the user and the UE to obtain the third result based on a on or off state of a screen, a frequency of user screen touches, and a frequency of data transmission between the UE and the network.

7. The method as claimed in claim 5, wherein the third result comprises a no interactive result, a low interactive result, a medium interactive result, and a high interactive result.

8. The method as claimed in claim 7, wherein the measurement strategy comprises:
performing a first action to stop inter-frequency or inter radio access technology (inter-RAT) measurements, and stop intra-frequency measurements except for a serving cell; or
performing a second action to stop the inter-frequency or inter-RAT measurements, and extend a cycle of the intra-frequency measurements by K times; or
performing a third action to extend a cycle of the inter-frequency or inter-RAT measurements by M times, and extend the cycle of the intra-frequency measurements by K times; wherein M and K are larger than one; or
performing a fourth action for normal measurements.

9. The method as claimed in claim 8, wherein the network does not configure relaxed Measurement-r16 to the UE.

10. The method as claimed in claim 9, further comprising:
performing the first action in response to meeting a first condition that the first result is the static-low mobility and the third result is the no interactive result or the low interactive result;
performing the second action in response to meeting a second condition that the first result is the walking-low mobility, the second result is the not cell edge result, and the third result is the no interactive result or the low interactive result;
performing the third action in response to meeting a third condition that the second result is the cell edge result and the third result being the no interactive result or the low interactive result; and
performing the fourth action in response to not meeting the first condition, the second condition, or the third condition.

11. The method as claimed in claim 8, wherein the UE enters an idle mode, and the network configures relaxed Measurement-r16 to the UE.

12. The method as claimed in claim 11, wherein the network configures relaxed Measurement-r16 with only low Mobility Evaluation-r16 IEs to the UE; wherein the method further comprises:
following Third Generation Partnership Project (3GPP) specification to perform relaxed measurements for intra cells, inter cells, and inter-RAT (IRAT) cells in response to the UE fulfilling relaxed measurement criteria;
performing the first action in response to the UE fulfilling relaxed measurement criteria, and meeting a first condition that the first result is the static-low mobility and the third result is the no interactive result or the low interactive result;
performing the second action in response to the UE fulfilling relaxed measurement criteria, and meeting a second condition that the first result is the walking-low mobility, the second result is the not cell edge result, and the third result is the no interactive result or the low interactive result; and
performing the fourth action in response to the UE fulfilling relaxed measurement criteria, and not meeting the first condition or the second condition.

13. The method as claimed in claim 12, the method further comprising:
performing the first action in response to the UE not fulfilling relaxed measurement criteria and meeting the first condition;
performing the second action in response to the UE not fulfilling relaxed measurement criteria and meeting the second condition; and
performing the fourth action in response to the UE not fulfilling relaxed measurement criteria and not meeting the first condition or the second condition.

14. A user equipment (UE), operating in a connected mode with a network, comprising:
a storage, configured to store codes for enhancing power saving;
a processor, electrically connected to the storage, configured to execute the codes to:
detect a mobility of the UE to obtain a first result;
detect whether the UE is located at a cell edge to obtain a second result;
detect interactive operations between a user and the UE to obtain a third result;
determine a measurement strategy based on at least one of the first result, the second result, and the third result, and
stop or slow down certain measurements based on the measurement strategy.

15. The UE as claimed in claim 14, wherein the processor is configured to:
detect the mobility of the UE to obtain the first result based on raw data from GPS, gyroscope, motion sensor, and measurement data;
wherein the first result comprises a static-low mobility, a walking-low mobility, and a not low mobility;
wherein the static-low mobility indicates that motion of the UE is stationary at a fixed place; the walking-low mobility indicates that the motion of the UE is walking or is similar to walking; the not low mobility includes other motions of the UE except for the static-low mobility and the walking-low mobility.

16. The UE as claimed in claim 14, wherein the processor is configured to:
detect whether the UE is located at the cell edge between a serving cell and neighbor cells to obtain the second result based on signal strength and quality from the serving cell, and signal strength and quality relative to the neighbor cells.

17. The UE as claimed in claim 15, wherein the second result comprises a not cell edge result and a cell edge result.

18. The UE as claimed in claim 14, wherein the processor is configured to:
detect the interactive operations between the user and the UE to obtain the third result based on a screen on or off state, a frequency of user screen touches, and a frequency of data transmission between the UE and the network.

19. The UE as claimed in claim 17, wherein the third result comprises a no interactive result, a low interactive result, a medium interactive result, and a high interactive result.

20. The UE as claimed in claim 19, wherein the measurement strategy comprises:
the processor performing a first action to stop inter-frequency or inter radio access technology (inter-RAT) measurements, and stop intra-frequency measurements except for a serving cell; or
the processor performing a second action to stop the inter-frequency or inter-RAT measurements, and extend the cycle of the intra-frequency measurements by K times; or
the processor performing a third action to extend the cycle of the inter-frequency or inter-RAT measurements by M times, and extend the cycle of the intra-frequency measurements by K times; wherein M and K are larger than one; or
the processor performing a fourth action for normal measurements.
